(19) United States
(12) Patent Application Publication
(10) Pub. No.: US 2025/0367894 A1
(43) Pub. Date: Dec. 4, 2025

(54) A METHOD OF ADHERING A DEVICE TO A TIRE

(71) Applicant: Bridgestone Europe NV/SA, Zaventem (BE)

(72) Inventors: Ciro Vecchione, Roma (IT); Robin Frank Arends, Roma (IT); Maria Cecilia Palumbi, Roma (IT)

(21) Appl. No.: 18/877,621

(22) PCT Filed: Jun. 23, 2023
(86) PCT No.: PCT/EP2023/067199

§ 371 Date: Dec. 20, 2024

(30) Foreign Application Priority Data
Jun. 27, 2022 (EP) 22181262.1

(51) Int. Cl. B29D 30/00; B60C 23/04

(52) U.S. Cl. CPC B29D 30/0061; B60C 23/0493; B29D 2030/0072

(57) ABSTRACT

The present invention relates to a method of adhering a device to a tyre, the method comprising: applying adhesive to a surface of the device, wherein applying adhesive comprises: applying an inner portion (14) of adhesive to the surface of the device (20); and applying an outer line (16) of adhesive to the surface of the device, wherein the outer line of adhesive at least partially surrounds the inner portion of adhesive; the method further comprising: applying the device to the tyre, wherein applying the device (20) to the tyre comprises: applying pressure to the device to spread the inner portion (14) and outer line (16) of adhesive over the device for creating a uniform film of adhesive between the device and the tyre. An embodiment of the invention relates to a method for manufacturing a tyre comprising said method of adhering a device to a tyre.

### FIELD

The present disclosure relates to a method of adhering a device, such as a radio frequency identification patch, to a tire.

### BACKGROUND

There are many advantages to being able to attach a device, such as a radio frequency identification (RFID) patch, to the inside of a tire. Such devices may allow smart monitoring and communication with the tire, which can provide many benefits. Tire supply logistics can be improved, for example by tracking delivery of tires, as well as managing stock levels. Devices can also facilitate improved vehicle monitoring, for example of the location or mileage of the tire, which in turn can feed in to predictive maintenance of the tire.

If a device detaches from a tire, it may be unable to provide a monitoring and communication function, or the device may be lost entirely. In such cases, it is no longer possible to benefit from the functionality of the device. It is therefore important that devices are firmly and robustly adhered to the tire to ensure the device is adhered to the tire throughout the entire life cycle of the tire.

In order to firmly adhere a device to a tire, a uniform layer of adhesive is advantageous, which covers substantially all of, or the majority of, the device. It is also desirable for the amount of adhesive to be controlled, depending on the type of device and glue. Devices with uneven, too much, or too little adhesive will often result in an unreliable attachment to the tire. Similarly, devices that have wrinkles or creases in them after being applied to a tire will also have an unreliable attachment.

Applying devices to every tire can be a time-consuming—and thus expensive—process, especially when devices are to be applied to large numbers of tires. It is therefore also desirable to provide a method that reliably provides a secure attachment without the need for significant time or expensive equipment.

### SUMMARY

It has been found that by adhering a device to a vulcanized tire using the methods described herein, a robust attachment is formed in a time-efficient manner. The present disclosure ensures a correct amount of adhesive is present, resulting in a secure attachment without wasting glue and while maintaining the integrity of the device being adhered to the tire. Importantly, the methods described herein overcome a number of the deficiencies with existing methods, which either suffer from a lack of adhesion, excessive glue use and discharge during attachment, or wrinkling or damage of the device as it is applied to a tire.

According to the disclosure is a method of adhering a device to a tire. The method comprises applying adhesive to a surface of the device and applying the device to a tire. Applying adhesive may comprise applying an inner portion of adhesive to the surface of the device. Applying adhesive may further comprise applying an outer line of adhesive to the surface of the device. The outer line of adhesive may at least partially surround the inner portion of adhesive. Applying the device to the tire may comprise applying pressure to the device. This may be to spread the inner portion and outer line of adhesive over the device for creating a uniform film of adhesive between the device and the tire.

The device may be a patch.

The device may be configured to connect or support a secondary component, such as a sensor or communication component. The device may be for monitoring a characteristic of the tire, such as temperature or internal pressure. The device may comprise a sensor, or may be configured to connect to or support a sensor. The device may be a support.

The device may be configured to store identification information for the tire. The device may be configured to wirelessly communicate with a scanner.

The device may be a device for monitoring a characteristic of the tire. The device may be a device for monitoring a characteristic of the tire environment. Example characteristics may include temperature, pressure or other physical or chemical properties of the tire. The device may be a radio frequency identification (RFID) patch. The device may provide a range of tracking, identification or monitoring functions to the tire, greatly improving performance or logistical management of the tire.

The device may be a holder type device, for example for holding a sensor.

The device may comprise an adhesion surface. The adhesion surface may be a surface of the device to which adhesive is applied and which is directly secured to the tire.

The device may be adhered to a tire using chemical adhesive such as glue. The adhesive may comprise, or be, a Cyanoacrylate. The adhesive may be Cyberbond 2240(™) or Sigel 3M™. The adhesive may be applied to a surface of the device—for example as a liquid or gel—before the device is applied to the tire. The adhesive may be allowed to cure or partially cure before the device is applied to the tire. Allowing the adhesive to partially cure may improve the adhesion of the device to the tire.

The inner portion of adhesive and outer line of adhesive may be the same adhesive. Using the same adhesive may simplify the process of applying the device to the tire.

The method may use only a single type of adhesive, alternatively the inner portion and outer line of adhesive may be different adhesives. The different types of adhesive may have different properties—for example curing times. Using different types of adhesive may allow the user to benefit from the advantages of each type of adhesive.

The total amount of adhesive, in grams per surface area, applied to form the inner portion and outer line of adhesive combined may be between 0.3 and 0.6 g/dm². This amount of adhesive may provide an optimal adhesion strength while avoiding excessive glue, which can result in wastage as well as a reduction in adhesion strength.

When the adhesive is Cyberbond 2240(™), the total amount of adhesive applied per unit area of the adhesive surface of the device may be between 0.3 and 0.5 g/dm². When the adhesive is Sigel 3M™, the total amount of adhesive applied per unit area of the adhesive surface of the device may be between 0.4 and 0.6 g/dm².

The inner portion of adhesive may be an inner line of adhesive.

The inner portion of adhesive may be applied on or along a centreline of the device. A centreline of the device may include a centre point or a circle (e.g. in the case of the device having a circular profile). The centreline of the device may be a longitudinal centreline.

The outer line of adhesive may be separate from the inner portion of adhesive. The outer line of adhesive may be distinct from the inner portion of adhesive.

The inner line and outer line may not be connected or intersect. They may be applied in separate steps or movements. The inner line of adhesive and outer line of adhesive may define a gap therebetween.

The outer line of adhesive may define a shape corresponding to the outer profile of the device.

Having a shape corresponding to the outer profile of the device may allow the outer line of adhesive to define a substantially constant distance between the outer line of adhesive and the outer edge of the device (e.g. the adhesion surface of the device). This may cause the adhesive of the outer line to be spread uniformly upon applying the device to the tire, over the area between the outer line of adhesive and the outer edge of the device.

The device may be obround, circular, oval, polygonal or rectangular. Accordingly, the outer line of adhesive may be obround, circular, oval, polygonal or rectangular.

The outer line of adhesive may be an unbroken line.

The outer line of adhesive may entirely surround the inner portion of adhesive.

A line of adhesive (inner, or outer) may be a solid, unbroken line, or a broken or dashed line. An unbroken line of adhesive may facilitate a more even spread of adhesive upon application of the device to the tire. A broken line of adhesive may allow the quantity of adhesive being applied be controlled, for example by controlling the number and spacing of line segments.

The outer line of adhesive may define a closed loop that encircles the inner portion of adhesive. This may facilitate a uniform application of adhesive over the adhesion surface after adhering the device to a tire.

The outer line of adhesive may be arranged to spread over an outer portion of the device. The outer line of adhesive may be arranged spaced from the outer edge of the device. During application of the device to the tire, the outer line of adhesive may spread over the area between the outer line of adhesive and the outer edge of the device to form a thin film. The size of the area between the outer line of adhesive and outer edge of the device may affect the ability of the adhesive to form a uniform thin film. If the outer line of adhesive is too close to the centre of the device, it may be unable to spread far enough to form a thin film over the entire adhesion surface. If the outer line of adhesive is too close to the edge of the device, adhesive may be expressed from between the device and the tire as pressure is applied to the device.

The distance between the outer edge of the device and the outer line of adhesive may be greater than an eighth and less than three quarters of the distance between the outer edge of the device and the inner portion of adhesive.

The distance between the outer edge of the device and the outer line of adhesive may be greater than a quarter and less than a half of the distance between the outer edge of the device and the inner portion of the adhesive.

The outer line of adhesive may be located in a band that circumscribes the inner portion of adhesive. The band may extend circumferentially around the device, or the adhesion surface thereof.

Measured from the outer edge, the band may extend between an eighth and three-quarters of the distance from the outer edge of the device to the inner portion of adhesive. Measured from the outer edge, the band may extend between from a quarter to a half of the distance between the outer edge and the inner portion of adhesive. The outer line of adhesive may surround the inner portion of adhesive and be offset from the outer edge of the device by between a quarter and a half of the distance between the outer edge of the device and inner portion of adhesive.

The distance between the outer edge of the device and the outer line of adhesive may be approximately equal to ⅜ (three eighths) of the distance between the outer edge of the device and the inner portion of adhesive.

The amount of adhesive applied to form the inner portion of adhesive may be between 80% and 120% of the amount of adhesive applied to form the outer line of adhesive.

Substantially equal amounts of adhesive may be applied as the inner portion and outer line of adhesive. The inner portion and outer line of adhesive may be configured to spread to cover approximately the same surface area of the device, when adhered to the tire. This provides a reliable method for achieving a substantially uniform adhesive layer.

In order to achieve a substantially equal amount of glue applied to form the inner line and outer line, the ratio of the amounts of glue applied for each line in grams per mm is inversely proportional to the lengths of the lines.

Applying the device to the tire may comprise applying the device to an inside of the tire. The device may be applied to an inside surface of the wall of a tire.

Applying the device to the tire may comprise first applying pressure to a centre of the device and moving the pressure outwards towards the outer edge of the device.

Initially applying pressure to a centre region of the device may comprise applying pressure to an area corresponding to that of the inner portion of adhesive. This may cause the inner portion of adhesive to spread over an inner area (e.g. half) of the device or adhesion surface thereof.

Subsequently moving the pressure outwards may cause the pressure to be moved towards, and eventually over, an area corresponding to the outer line of adhesive. This may cause the outer line of adhesive to spread, generally outwardly, towards the outer edge of the device. This may cause the outer line of adhesive to spread over an outer area (e.g. half) of the device.

Applying pressure in this manner in combination with applying adhesive in this manner may achieve a previously unattainable reliability in achieving a uniform thin film of adhesive.

Applying the device to the tire may comprise applying between 80 and 120 kPa of pressure.

The pressure may be between 50 and 150 kPa, 80 and 120 kPa or 90 and 110 kPa. The pressure may be 100 kPa. The selected levels of pressure achieve a robust attachment of the device to the tire.

Applying the device to the tire may comprise applying the pressure for between 1 and 180 seconds.

Pressure may be applied for between 1 and 300 seconds, or 1 and 180 seconds, or between 3 and 90 seconds. Applying pressure for the selected durations provides a robust adherence.

Further according to the present disclosure is a method for manufacturing a tire comprising a method for adhering a device to a tire as described anywhere herein.

Further according to the disclosure is a tire manufactured as described herein.

### BRIEF DESCRIPTION OF DRAWINGS

FIG. 1 is a flow chart of a method of adhering a device to a tire;

FIG. 2 is a plan view of a RFID patch for adhering to a tire;

FIG. 3A is a plan view of a device for adhering to a tire; and

FIG. 3B is a side view of the device of FIG. 3A adhered to a tire.

### DETAILED DESCRIPTION OF DRAWINGS

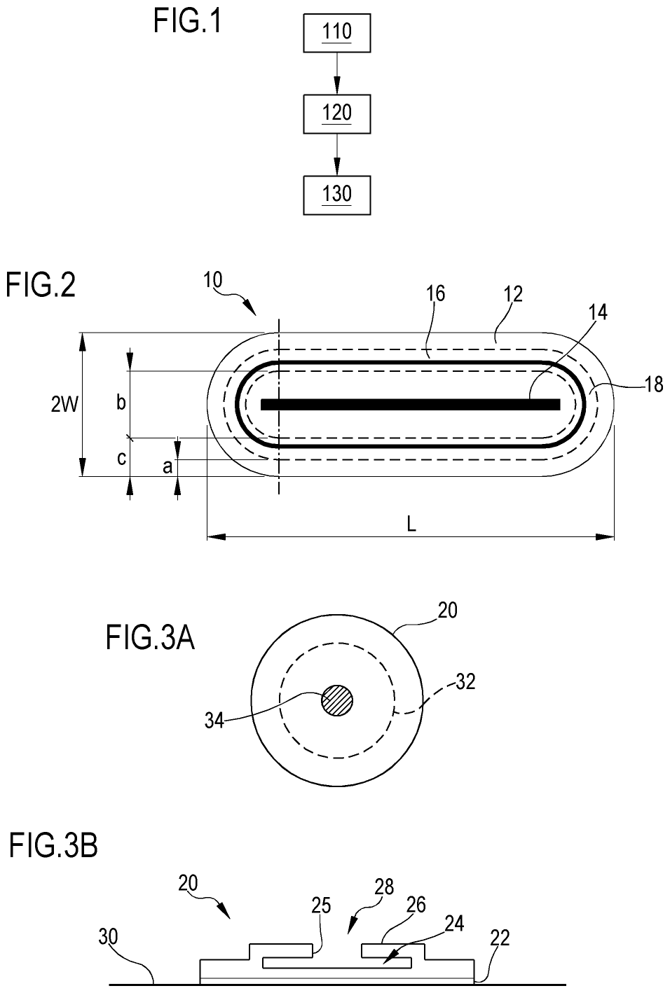

FIG. 1 is a flow chart of a method of adhering a device to a tire as disclosed herein. In the flow chart of FIG. 1 a specific order of steps is shown, however it is to be understood that in other examples according to this disclosure, the order of certain steps may be different to that shown in FIG. 1.

In a first step 110, a first portion of adhesive is applied to a surface of the device to be adhered to a tire. This surface will typically be a generally flat underside of the device—for example a flat surface of an RFID patch (e.g. as shown in FIG. 2), or an underside of a “holder” type device (e.g. as shown in FIG. 3).

The adhesive is a liquid or gel adhesive that is applied to the device, for example by a glue gun. The adhesive is applied to the device shortly before application of the device to the tire. Applying the adhesive in such a manner is quick and reliable.

The first portion of adhesive is an inner portion of adhesive and is applied towards the centre of the surface. The first portion of adhesive may be a line of adhesive or a single spot of adhesive. The first portion of adhesive may be applied on or along part or the whole of a centreline of the device.

In the present example, the first portion of adhesive is configured to cover a central portion of the area to be adhered during use. The first portion of adhesive is configured to spread over the central area of the device (e.g. the patch) after application of the device to the tire, to form a thin film of adhesive to adhere that portion of the surface to the tire. The first portion of adhesive is configured (e.g. located and portioned) to cover substantially half of the surface area to be adhered—e.g. half of the surface of the patch.

In some examples, the adhesive is Cyberbond 2240(™) or Sigel 3M™.

In a second step 120, a second portion of adhesive is applied to the surface. The second portion is an outer line of adhesive. The outer line of adhesive is applied to at least partially surround the inner portion of adhesive.

In the present example, the outer line of adhesive is configured to cover an outer portion of the area to be adhered to the tire, during use. The outer line of adhesive, is configured to spread over an outer area of the device (e.g. the patch) after application of the device to the tire, to form a thin film of adhesive to adhere that portion of the surface to the tire. The outer line of adhesive is configured (e.g. located and portioned) to cover substantially half of the surface area to be adhered—e.g. half of the surface of the patch.

The outer line of adhesive comprises substantially the same amount of adhesive as the inner portion of adhesive.

In the present example, between 0.3 and 0.6 g/dm² of adhesive are applied to the device.

Applying the adhesive in two distinct parts—the inner portion and outer line—allows the adhesive to be rapidly applied to the device, and provides an arrangement in which the adhesive is reliably spread over the adhesion surface.

The outer line of adhesive is the same adhesive as that of the inner portion of adhesive.

In some examples, and depending on the specific adhesive used, the device and adhesive may be left for the glue to cure for a period of time.

Once the adhesive has been applied to the device, and optionally allowed to cure, the method progresses to step 130 in which the device is applied to the tire. The device may be applied by hand, or machine.

Applying the device to the tire 130 comprises locating the device at the desired location and applying pressure to the device to secure it to the tire. The pressure is applied to spread the inner portion and outer line of adhesive over the entire adhesion surface. The adhesive is spread to create uniform thickness of adhesive film between the device and tire. A uniform thickness of adhesive film provides a more reliable and strong bond.

In order to create a uniform thickness of adhesive film, in the present example, pressure is first applied to a centre portion of the adhesion surface of the device and then moved outwards towards the outside of the device. This effects the spreading of the inner portion of adhesive from the centre of the adhesive surface, out towards the outer line of adhesive. The inner portion of adhesive provides a uniform thin film of adhesive over approximately 50% of the adhesion surface. The outer line of adhesive is then spread outwards towards the outer profile of the device. The outer line of adhesive forms a uniform thin film of adhesive over the remaining 50% of the adhesion surface.

Pressure is applied to the device for between 1 and 180 seconds. In this specific example, pressure is applied for between 3 and 90 seconds. The pressure applied to the device is between 80 and 120 kPa. Applying pressure for the correct amount of time, and with the correct amount of force, is important for achieving a robust bond between the device and the tire.

FIG. 2 shows an example of a device for use in the present disclosure. FIG. 2 shows adhesive applied to an underside 12 of a device 10, for applying to a tire in accordance with a method described herein.

The device 10 of FIG. 2 is an RFID patch 10. The patch is planar and obround in shape. FIG. 2 shows an underside 12 of the patch 10. The underside 12 is the adhesion surface of the patch, i.e. that which is to be secured to the tire. FIG. 2 shows the patch 10 before being applied to a tire.

An inner portion 14 of adhesive has been applied to the patch 10. The inner portion 14 of adhesive in the present example is a line of adhesive along the centreline of the RFID patch 10. The centreline runs longitudinally along the middle of the patch 10. The amount of adhesive applied as the inner portion 14 is selected to cover substantially half of the underside 12 of the RFID patch 10 once the patch is applied to the tire—an inner part of the adhesion surface of the RFID patch 10.

An outer line 16 of adhesive has been applied the underside 12 of the RFID patch 10. The outer line 16 of adhesive is an unbroken line of adhesive. The outer line 16 of adhesive entirely surrounds the inner portion 14 of adhesive. The amount of adhesive applied as the outer portion 16 is selected to cover substantially half of the underside of the RFID patch 10 once the patch is applied to the tire—an outer circumferential portion of the RFID patch 10.

In the present example, the adhesive is Cyberbond 2240(™) and a total amount of adhesive (i.e. including both the inner portion and outer line) is applied such that there is 0.3-0.5 g/dm² for the patch as a whole. Substantially half of this adhesive forms the inner portion and half forms the outer portion. As the inner portion and outer line of adhesive have substantially the same amount of adhesive, the ratio of the cross-sections of the inner portion of adhesive and outer line of adhesive (i.e. the widths multiplied by the thicknesses of the lines) are inversely proportional to the lengths of the two lines. In other words, the amount of glue applied per millimetre of line is inversely proportional to the lengths of the line.

The outer line 16 of adhesive has a profile (i.e. shape) corresponding to that of the outer profile of the patch 10. In the present example, the outer line 16 is obround in shape.

The outer line 16 of adhesive is applied within a band 18 of the underside 12 of the patch 10. The band 18 represents an area of the adhesion surface in which the outer line 16 can be applied and still achieve a substantially uniform film thickness once the device is applied to the tire. The band 18 is a circumferential band located between the centre and the outer edge of the patch. The band 18 extends from a first distance a from the outer edge of the patch 10 to a second distance c from the outer edge of the patch 10.

In the present example, where the total width of the patch is 2 W, the band 18 extends from 0.25 W from the outer edge of the patch 10 to 0.5 W from the outer edge of the patch—that is, the band 18 extends from an eighth of the total width of the patch from the outer edge, to a quarter of the total width of the patch from the outer edge.

To apply the patch 10 of FIG. 2 to a tire, the underside 12 is located against the tire and pressure is applied to spread the inner line 14 and outer line 16 of adhesive into a uniform film of adhesive between the patch 10 and the tire. Pressure is first applied towards the centre of the patch 10 i.e. corresponding to the location of the inner portion 14 of adhesive to spread the inner portion of adhesive. Pressure is then moved outwards towards the outer line 16 of adhesive, to spread the outer line 16 of adhesive towards the outer edge of the patch 10. Approximately 100 kPa of pressure is applied for approximately 60 seconds. The patch 10 is then adhered to the tire.

FIG. 3A is a bottom view of a second device 20 for adhering to a tire. FIG. 3B is a side view of the same device 20 adhered to a tire 30.

The device 20 of FIGS. 3A and 3B is holder type device that is it is configured to support a secondary device or component. The device 20 is circular. The device 20 is substantially flat with a recess 28 configured to receive and hold a second device, such as a sensor (not shown), for example a TMS (Tire Mounted Sensor). The recess comprises a cavity 24 within the body of the device 20 and an aperture 25 defined by a flange 26 of the device. The cavity is configured to receive part of the secondary component and the aperture 25 and flange 26 are configured to prevent the secondary component from inadvertently separating from the device 20 during use.

As shown in FIG. 3A, adhesive is applied to an adhesion surface of the device (i.e. a surface to be adhered to the tire 30). In this case, the adhesion surface is a flat underside of the device 20.

An inner portion 34 has been applied as a central blob or circular mass of adhesive. Substantially half of the total adhesive applied to the device 20 is applied as this central mass of adhesive. In other examples, the inner portion 34 of adhesive may be applied as a circular line of adhesive.

In FIG. 3A, the outer line 32 of adhesive has been applied in a circular profile, corresponding to the outer profile of the device 20. The outer line 32 of adhesive is a broken, or dashed line. In other examples the outer line 32 may be a solid line of adhesive. In the example of FIG. 3A, the outer line 32 of adhesive is located roughly one third of the way from the outer profile to the centre of the device 20. That is, the outer line of adhesive is spaced from the outer edge of the patch by about r/3, where r is the radius of the device 20.

The device 20 is applied to the surface of the tire 30 by applying pressure to the device, to spread the inner portion and outer line of adhesive over substantially the entire adhesion surface in a substantially uniform film. FIG. 3B shows the device 20 adhered to a tire 30. A thin film of adhesive 22 can be seen between the device 20 and the tire 30. The substantially uniform, thin film of adhesive 22 robustly secures the device onto the tire 30.

The present invention has been described above purely by way of example. Modifications in detail may be made to the present invention within the scope of the claims as appended hereto. Furthermore, features from one example may be combined with an alternative example unless such a combination is explicitly precluded.

1-15. (canceled)

16. A method of adhering a device to a tire, the method comprising:
applying adhesive to a surface of the device, wherein applying adhesive comprises:
applying an inner portion of adhesive to the surface of the device; and
applying an outer line of adhesive to the surface of the device, wherein the outer line of adhesive at least partially surrounds the inner portion of adhesive;
applying the device to the tire, wherein applying the device to the tire comprises:
applying pressure to the device to spread the inner portion of adhesive and the outer line of adhesive over the device for creating a uniform film of adhesive between the device and the tire.

17. The method of claim 16, wherein the inner portion of adhesive and the outer line of adhesive are the same adhesive.

18. The method of claim 16, wherein the device is a radio frequency identification (RFID) patch.

19. The method of claim 16, wherein the device is a holder type device for holding a sensor.

20. The method of claim 16, wherein the inner portion of adhesive is an inner line of adhesive.

21. The method of claim 16, wherein the outer line of adhesive is separate and distinct from the inner portion of adhesive.

22. The method of claim 16, wherein the inner portion of adhesive is applied on or along a centreline of the device.

23. The method of claim 16, wherein the outer line of adhesive defines a shape corresponding to the outer profile of the device.

24. The method of claim 16, wherein the outer line of adhesive is an unbroken line that entirely surrounds the inner portion of adhesive.

25. The method of claim 16, wherein a distance between an outer edge of the device and the outer line of adhesive is greater than an eighth and less than three quarters of a distance between the outer edge of the device and the inner portion of adhesive.

26. The method of claim 16, wherein an amount of adhesive applied to form the inner portion of adhesive is between 80% and 120% of an amount of adhesive applied to form the outer line of adhesive.

27. The method of claim 16, wherein a total amount of adhesive, in grams per surface area, applied to form the inner portion and outer line of adhesive combined is between 0.3 and 0.6 g/dm².

28. The method of claim 16, wherein applying the device to the tire comprises first applying pressure to a centre of the device and moving the pressure outwards towards the outer of the device.

29. The method of claim 16, wherein applying the device to the tire comprises applying between 80 and 120 kPa of pressure.

30. The method of claim 29, wherein applying the device to the tire comprises applying between 90 and 110 kPa of pressure.

31. The method of claim 29, wherein applying the device to the tire comprises applying 100 kPa of pressure.

32. The method of claim 16, wherein applying the device to the tire comprises applying the pressure for between 1 and 180 seconds.

33. The method of claim 32, wherein applying the device to the tire comprises applying the pressure for between 3 and 90 seconds.

34. A method for manufacturing a tire, comprising the method of claim 16.

35. A tire comprising a device adhered thereto, and having a uniform film of adhesive between the device and the tire, the tire having been manufactured according to the method of claim 34.
